(19) United States
(12) Patent Application Publication
(10) Pub. No.: US 2005/0188503 A1
(43) Pub. Date: Sep. 1, 2005

(54) Hinge assembly for foldable electronic device

(75) Inventors: Chao Duan, Shenzhen (CN); Rui-Hao Chen, Shenzhen (CN); Chia-Hua Chen, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/015,985

(22) Filed: Dec. 17, 2004

(30) Foreign Application Priority Data
Feb. 28, 2004 (CN) 200420043232.7

(51) Int. Cl. E05F 1/08

(52) U.S. Cl. 16/303

(57) ABSTRACT

A hinge assembly includes a body drive member (1) having an outer screw thread (14), a cover drive member (2), and a locating member (3). The cover drive member has a hole (212), and an inner screw thread (215) therein. Two arms (223) extend from opposite edges of the cover drive member, and a bent portion (227) is formed at a distal end of each arm. The locating member has a projection (32) on an outer periphery thereof, and defines a hole. The body drive member extends through the hole of the cover drive member and the hole of the locating member, thereby integrating the hinge assembly into a complete unit, with the outer screw thread engaging with the inner screw thread, and the bent portion abutting the projection. The hinge assembly exerts reduced force on a foldable electronic device when the foldable electronic device is opened or closed.

### CROSS-REFERENCE TO RELATED APPLICATIONS

This application is related to U.S. patent application Ser. No. 10/904,797, entitled “HINGE ASSEMBLY FOR FOLDABLE ELECTRONIC DEVICE”, filed on Nov. 30, 2004 with the same assignee as the instant application. The disclosure of the above identified application is incorporated herein by reference.

### BACKGROUND OF THE INVENTION

1. Field of the Invention

The present invention relates to hinge assemblies, and particularly to a hinge assembly for foldable electronic devices such as mobile telephones, electronic notebooks, and so on.

2. Description of Prior Art

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body. The other housing, called the cover, normally contains fewer electronic components than the body. Other foldable electronic devices have all the electronics in the body, with the cover containing no electronics. Various types of hinge assemblies are used to join a body and a cover of a foldable electronic device, so that the cover can unfold up from and fold down upon the body.

U.S. Pat. No. 6,175,990 issued on Jan. 23, 2001 provides a hinge assembly used in a small-size foldable electronic device such as a portable telephone, a portable computer, an electronic notebook or the like. As represented in FIG. 8, the hinge assembly includes a shaft 10 provided with a discoid head 102 at a first end portion thereof, a fixing member 20, a fixed cam 30, a rotary sliding cam 40, and a compression spring 50. An opposite second end portion of the shaft 10 is extended through the fixed cam 30, the rotary sliding cam 40, the compression spring 50 and the fixing member 20 in that order, thereby integrating the hinge assembly into a complete unit.

The fixed cam 30 abuts the head 102 of the shaft 10, and is rotatable relative to the shaft 10. A pair of opposite recessed cam portions 302 is defined on an end of the fixed cam 30. A pair of opposite projection portions 402 is formed on an end face of the rotary sliding cam 40, corresponding to the cam portions 302. With the engagement of the cam portions 302 and the projection portions 402, the fixed cam 30 and the rotary sliding cam 40 are axially movable relative to each other and rotatable relative to each other. The rotary sliding cam 40 is axially movable relative to the shaft 10, and rotatable with the shaft 10. The fixing member 20 is secured around the second end portion of the shaft 10. The compression spring 50 is elastically engaged around the shaft 10 between the rotary sliding cam 40 and the fixing member 20, and continually presses the rotary sliding cam 40 against the fixed cam 30.

When the projection portions 402 of the rotary sliding cam 40 are engaged with the cam portions 302 of the fixed cam 30, the foldable electronic device is closed. When the foldable electronic device is opened, the projection portions 402 move out from engagement with the cam portions 302 onto coplanar end faces of the fixed cam 30. Once the foldable electronic device is opened to an angle of about 160°, the projection portions 402 snappingly engage into the corresponding cam portions 302 and are locked therein. However, during the process of the foldable electronic device being opened, a body and a cover of the foldable electronic device are directly subjected to force produced by the fixed cam 30, the rotary sliding cam 40 and the compression spring 50. This force is liable to cause damage to the body and the cover.

In view of the above-described shortcomings, a new, safer and more durable hinge assembly is desired.

### SUMMARY OF THE INVENTION

An object of the present invention is to provide a hinge assembly which can reduce the force it exerts on a foldable electronic device when the foldable electronic device is opened or closed.

A hinge assembly according to the present invention includes a body drive member, a cover drive member, and a locating member. The body drive member has an outer screw thread. The cover drive member has a central hole, and an inner screw thread formed in the central hole. A pair of symmetric arcuate arms extends from two opposite edges of the cover drive member, and a bent portion is formed at a distal end of each of the arms. The locating member has a projection formed on an outer periphery thereof, and defines a central hole. The body drive member extends through the hole of the cover drive member and the hole of the locating member, thereby integrating the hinge assembly into a complete unit, with the outer screw thread of the body drive member engaging with the inner screw thread of the cover drive member, and the bent portion of the cover drive member abutting the projection of the locating member.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a hinge assembly according to a preferred embodiment of the present invention, the hinge assembly including a locating member;

FIG. 2 is similar to FIG. 1, but viewed from a reverse aspect;

FIG. 3 is an enlarged, assembled view of the hinge assembly according to the preferred embodiment of the present invention, showing the hinge assembly positioned corresponding to a closed position of a foldable electronic device;

FIG. 4 is a cut-away view of the hinge assembly of FIG. 3;

FIG. 5 is similar to FIG. 3, but showing the hinge assembly positioned corresponding to an open position of the foldable electronic device;

FIG. 6 is a cut-away view of the hinge assembly of FIG. 5;

FIG. 7 is an enlarged, isometric view of a locating member according to an alternative embodiment of the present invention; and

FIG. 8 is an exploded, isometric view of a conventional hinge assembly.

### DETAILED DESCRIPTION OF THE INVENTION

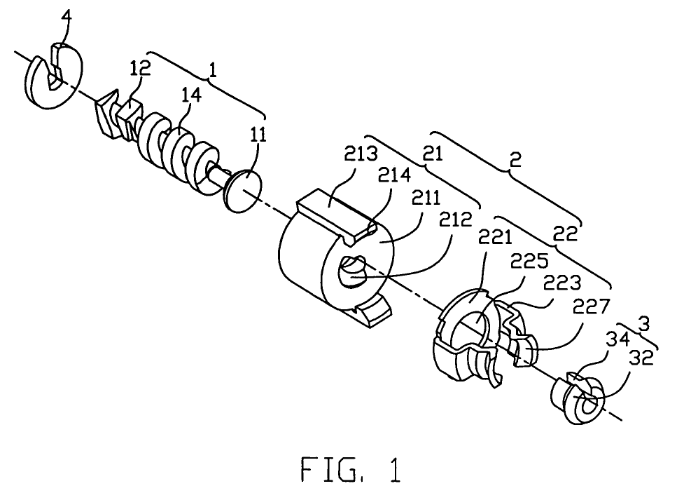

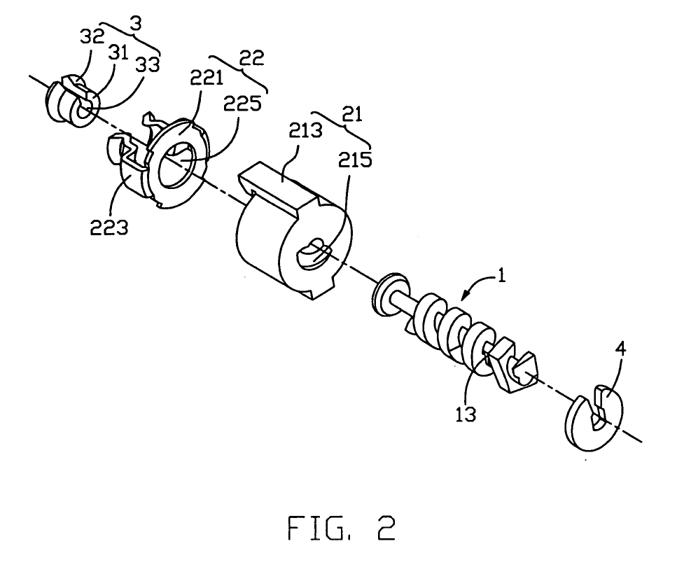

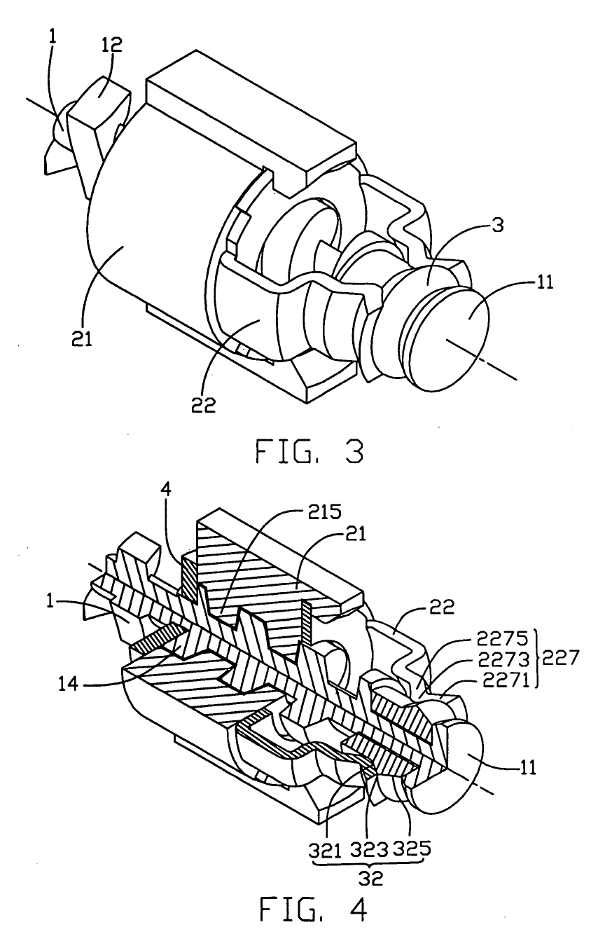

FIG. 3 shows a hinge assembly according to the preferred embodiment of the present invention, which is used to interconnect components like a body (not shown) and a cover (not shown) of a foldable electronic device. Also referring to FIGS. 1 and 2, the hinge assembly includes a body drive member 1, a cover drive member 2, a locating member 3, and a disk 4. The body drive member 1 extends through the cover drive member 2, the locating member 3 and the disk 4, thereby integrating the hinge assembly into a complete unit.

The body drive member 1 is a shaft essentially in the form of a round rod. A discoid head 11 is formed at a first end of the body drive member 1, and a lock member 12 is formed at an opposite second end of the body drive member 1. The lock member 12 is engaged with the body of the foldable electronic device, so that the body drive member 1 does not rotate relative to the body. A pair of opposite slots 13 is defined in the body drive member 1, adjacent the lock member 12. An outer screw thread 14 is formed on a periphery of the body drive member 1 between the slots 13 and the head 11.

The cover drive member 2 includes a rotary portion 21 and a follower portion 22. The follower portion 22 is held to the rotary portion 21, and moves in unison with the rotary portion 21.

The rotary portion 21 is in the form of a hollow cylinder, and has a tubular body 211 and a central cavity 212. A pair of protrusions 213 is provided on an outer periphery of the tubular body 211, and the protrusions 213 are circumferentially spaced apart according to a predetermined angle. The protrusions 213 are engaged with the cover of the foldable electronic device, so that the rotary portion 21 and hence the cover drive member 2 are rotatable in unison with the cover. An inner screw thread 215 is formed on an inside wall of the tubular body 211. Each of the protrusions 213 has a claw 214 extending axially inwardly from a distal end thereof. The inner screw thread 215 is engaged with the outer screw thread 14 of the body drive member 1, so that the rotary portion 21 and hence the cover drive member 2 can pivot relative to the body drive member 1.

The follower portion 22 has a base board 221. A round hatch 225 is defined in a center of the base board 221, and is coaxial with the cavity 212 of the rotary portion 21. A pair of symmetric arcuate arms 223 extends perpendicularly from two opposite edges of the base board 221 respectively. A distal end of each arm 223 is bent radially inwardly to form a bent portion 227. As shown in FIG. 4, the bent portion 227 has two slopes 2271, 2275 at opposite sides of a ridge 2273 respectively. The follower portion 22 is held to the rotary portion 21 by way of the claws 214 of the rotary portion 21 grasping the base board 221 of the follower portion 22.

The locating member 3 is made of an elastic material, and has a generally cylinder body 31 and a central hole 33. A diameter of the hole 33 is less than a diameter of the head 11 of the body drive member 1. A cutout 34 is axially defined through the body 31 in communication with the hole 33. A generally annular projection 32 is formed on a circumferential periphery of the body 31. As shown in FIG. 4, the projection 32 has two slopes 321, 325 at opposite sides of a ridge 323 respectively.

The disk 4 is made of metallic material, and defines a generally Y-shaped notch (not labeled) therein. This enables the disk 4 to be snappingly secured on the body drive member 1 in the slots 13.

In assembly of the hinge assembly, the rotary portion 21 and the follower portion 22 of the cover drive member 2 are fixed together by way of the claws 214 of the rotary portion 21 grasping the base board 221 of the follower portion 22. The second end of the body drive member 1 is inserted through the hole 33 of the locating member 3 and the hatch 225 of the follower portion 22. The second end of the body drive member 1 is rotated into the cavity 212 of the rotary portion 21, with the outer screw thread 14 of the body drive member 1 engaging with the inner screw thread 215 of the rotary portion 21 of the cover drive member 2, until the head 11 abuts the locating member 3. The disk 4 is secured on the first end of the body drive member 1 in the slots 13. One end of the rotary portion 21 abuts the disk 4. The bent portions 227 of the follower portion 22 abut the projection 32 of the locating member 3, with the slopes 2271 of the bent portions 227 slidably abutting against the slope 321 of the projection 32. The hinge assembly is thus completely assembled, as shown in FIGS. 3 and 4.

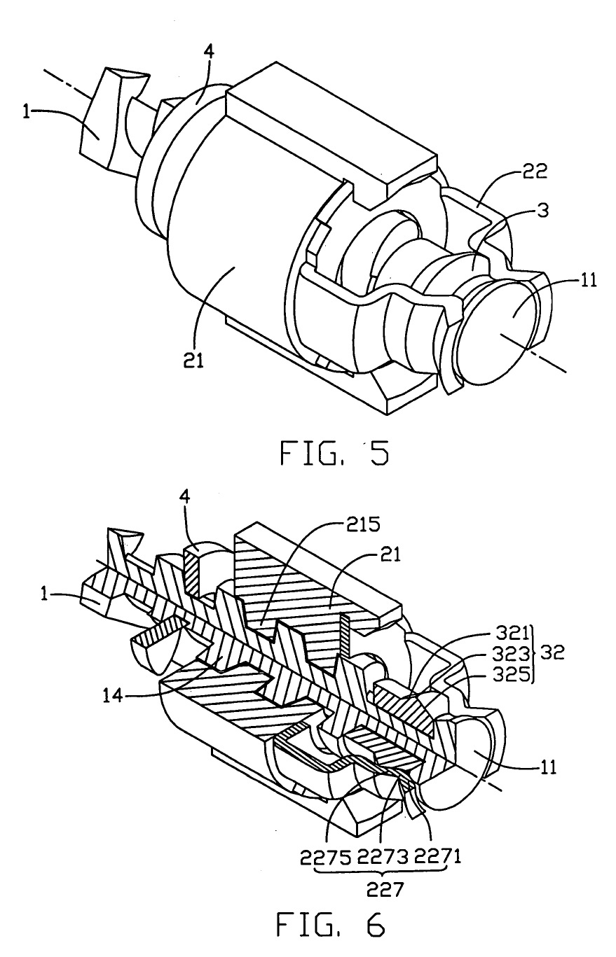

Referring to FIGS. 3-6, when the slope 321 of the projection 32 of the locating member 3 abuts against the slopes 2271 of the bent portions 227 of the follower portion 22, the cover of the foldable electronic device is held in a fully closed position. To open the foldable electronic device, the cover is manually rotated up from the body. Hence the cover drive member 2 is rotated about the body drive member 1. With the engagement of the outer screw thread 14 of the body drive member 1 and the inner screw thread 215 of the rotary portion 21 of the cover drive member 2, the cover drive member 2 is thereby axially moved away from the disk 4. In this process, the slopes 2271 ride along the slope 321, and the locating member 3 is compressed radially inwardly. Once the ridges 2273 of the bent portions 227 have ridden over the ridge 323 of the projection 32, the locating member 3 decompresses and drives the follower portion 22 to continue moving axially in the same direction, with the slopes 2275 of the bent portions 227 riding along the slope 325 of the projection 32. Hence the cover drive member 2 continues to rotate in the opening direction under the decompression force of the locating member 3. The cover is thus opened automatically to a fully open position at which the follower portion 22 abuts the head 11 of the body drive member 1, as shown in FIGS. 5 and 6.

To close the foldable electronic device, the cover is manually rotated down toward the body. Hence the cover drive member 2 is rotated about the body drive member 1. With the engagement of the outer screw thread 14 and the inner screw thread 215, the cover drive member 2 is thereby axially moved away from the head 11 of the body drive member 1. As a result, the slopes 2275 ride along the slope 325, and the locating member 3 is compressed radially inwardly. Once the ridges 2273 have ridden over the ridge 323, the locating member 3 decompresses and drives the follower portion 22 to continue moving axially in the same direction, with the slopes 2271 riding along the slope 321. Hence the cover drive member 2 continues to rotate in the closing direction under the decompression force of the locating member 3. The cover is thus closed automatically to the fully closed position at which the rotary portion 21 abuts the disk 4, as shown in FIGS. 3 and 4.

During the processes of the cover automatically opening or closing, the cover drive member 2 and hence the cover are subjected to the decompression force of the compressed locating member 3. The slopes 2271/2275 of the bent portions 227 are in slidable contact with the corresponding slopes 321/325 of the projection 32, which produces an amount of friction between the cover drive member 2 and the locating member 3. This limits the speed of opening and closing of the cover, so that the cover is protected from damage.

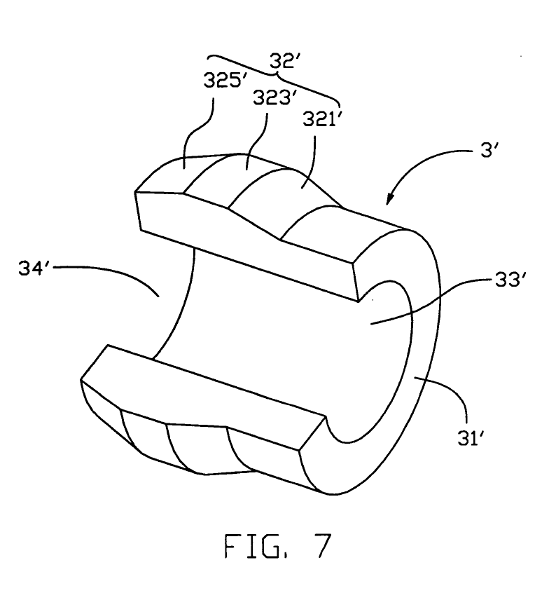

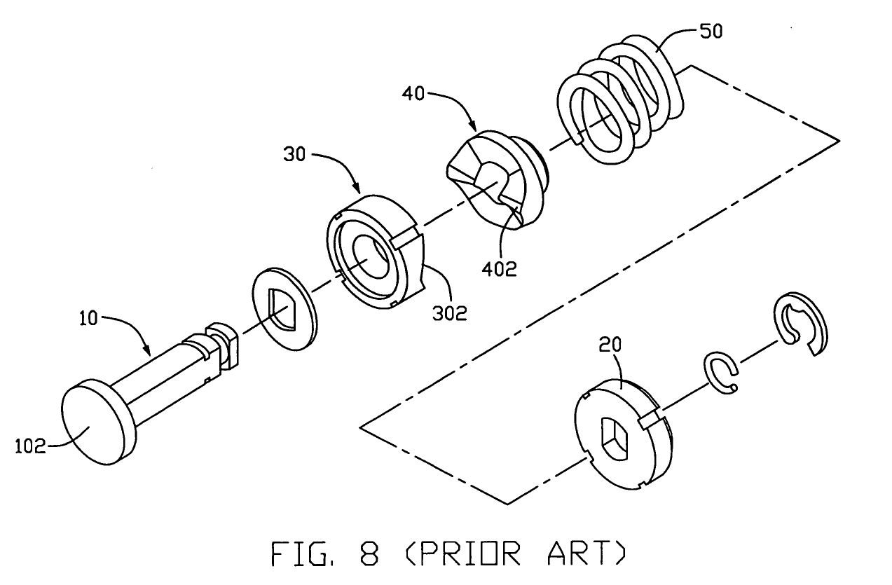

Referring to FIG. 7, a locating member 3′ in accordance with an alternative embodiment of the present invention has a generally cylinder body 31′ and a central hole 33′. A cutout 34′ is axially defined through the body 31′ in communication with the hole 33′. A generally annular projection 32′ is formed on a circumferential periphery of the body 31′. The projection 32′ has two slopes 321′, 325′ at opposite sides of a ridge 323′ respectively. The ridge 323′ has a flat surface. During rotation of the cover of the foldable electronic device, when the ridges 2273 of the bent portions 227 reach the ridge 323′ of the projection 32′, the flat surface of the ridge 323′ enables the bent portions 227 to remain stably in position. That is, the cover drive member 2 can remain stable relative to the locating member 3′ at any of a plurality of positions at which the ridges 2273 are in contact with the ridge 323′. Accordingly, the cover drive member 2 can be stably held relative to the body drive member 1 at a plurality of positions. This means that the cover can be located to and automatically held at any of a plurality of partly open positions. Further or alternatively, in similar fashion, the ridges 2273 of the bent portions 227 may each have a flat surface.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hinge assembly for a foldable electronic device, comprising:
a body drive member having an outer screw thread;
a cover drive member having a central hole and an inner screw thread formed in the central hole, at least one arm extending from one end of the cover drive member, a distal end of said arm having a bent portion;
and a locating member having a projection formed on an outer periphery thereof, and defining a central hole;
wherein the body drive member extends through the hole of the cover drive member and the hole of the locating member, thereby integrating the hinge assembly into a complete unit, with the outer screw thread of the body drive member engaging with the inner screw thread of the cover drive member, and with the bent portion of the cover drive member abutting the projection of the locating member.

2. The hinge assembly as claimed in claim 1, wherein the body drive member is a shaft essentially in the form of a round rod.

3. The hinge assembly as claimed in claim 2, wherein an enlarged head is provided at a first end of the body drive member.

4. The hinge assembly as claimed in claim 3, wherein a lock member is formed at an opposite second end of the body drive member.

5. The hinge assembly as claimed in claim 4, wherein the body drive member defines at least one slot adjacent the lock member.

6. The hinge assembly as claimed in claim 5, further comprising a disk defining a notch.

7. The hinge assembly as claimed in claim 1, wherein the cover drive member comprises a rotary portion and a follower portion, and the rotary portion and the follower portion are fixed together.

8. The hinge assembly as claimed in claim 7, wherein the rotary portion is in the form of a hollow cylinder, and has a tubular body and a central cavity.

9. The hinge assembly as claimed in claim 8, wherein the inner screw thread is formed on an inside wall of the rotary portion.

10. The hinge assembly as claimed in claim 8, wherein at least one protrusion is formed on a circumferential periphery of the tubular body of the rotary portion.

11. The hinge assembly as claimed in claim 10, wherein said protrusion has a claw axially extending therefrom, the follower portion has a base board, and the rotary portion and the follower portion are fixed together by way of the claw of the rotary portion grasping the base board of the follower portion.

12. The hinge assembly as claimed in claim 11, wherein said arm extends from an edge of the base board of the follower portion.

13. The hinge assembly as claimed in claim 1, wherein the locating member axially defines a cutout in communication with the hole thereof.

14. The hinge assembly as claimed in claim 1, wherein a ridge of the projection of the locating member has a flat surface.

15. The hinge assembly as claimed in claim 1, wherein a ridge of the bent portion of the cover drive member has a flat surface.

16. A hinge assembly for rotary interconnection of components of an electronic device, comprising:
a first drive member attached to one of said components and moving together therewith;
a second drive member attached to another of said components and moving together therewith, and engagable with said first drive member to rotate relatively to said first drive member;
and a locating member elastically secured on one of said first and second drive members and having a frictional engagement with another of said first and second drive members to reduce rotation speed of said second drive member relative to said first drive member.

17. The hinge assembly as claimed in claim 16, wherein a metal follower portion is securely attached to said second drive member and has at least one arm to frictionally engage with said locating member.

18. A method for rotary interconnection of components of an electronic device, comprising the steps of:
installing a first drive member to one of said components to allow said first drive member to move together with said one of said components;
installing a second drive member to another of said components to allow said second drive member to move together with said another of said components;
engaging rotatablly said second drive member with said first drive member; and
providing a locating member elastically secured on one of said first and second drive members to have a frictional engagement with another of said first and second drive members during rotation of said second drive member relative to said first drive member.
